(19) United States
(12) Patent Application Publication
(10) Pub. No.: US 2013/0278481 A1
(43) Pub. Date: Oct. 24, 2013

(54) Wideband Antenna Using Electromagnetic Bandgap Structures

(71) Applicants: David R. Voltmer, Terre Haute, IN (US); Eric R. Wandel, Newburgh, IN (US); Edward Dean Wheeler, Terre Haute, IN (US)

(72) Inventors: David R. Voltmer, Terre Haute, IN (US); Eric R. Wandel, Newburgh, IN (US); Edward Dean Wheeler, Terre Haute, IN (US)

(21) Appl. No.: 13/654,412

(22) Filed: Oct. 17, 2012

Related U.S. Application Data
(60) Provisional application No. 61/548,178, filed on Oct. 17, 2011.

(51) Int. Cl. H01Q 15/00; H01Q 1/22

(52) U.S. Cl. CPC H01Q 15/0006; H01Q 1/22
USPC 343/904; 343/913

(57) ABSTRACT

The present invention relates to the field of antennas and specifically to broadband antennas. Planar low-profile antennas over high-impedance surfaces show improved performance compared to that over metal ground planes, but these high-impedance surfaces often operate over narrow bandwidths because current approaches to the design of high-impedance substrates typically employ identical unit cells with the same resonant frequency to produce high-impedance behavior over a relatively narrow frequency range. The present invention provides improved antenna performance over a broader bandwidth through the use of electromagnetic bandgap cells having a size and related resonant frequency that varies with position to the antenna radiating element in order to match the resonance of the element.

### REFERENCES

[1] D. Sievenpiper et al, “High-Impedance Electromagnetic Surfaces with a Forbidden Frequency Band,” IEEE Trans. Microwave Theory Tech., vol 47, pp 2059-2074, November 1999.
[2] N. Enghetta and R. W. Ziolkowski (editors), Metamaterials: Physics and Engineering Explorations, IEEE Press by J. Wiley & Sons, Hoboken, N.J., 2006.
[3] N. Jing, H. Zhao, and L. Huang, “A Novel Design of Planar Spiral Antenna with Metamaterial,” Progress In Electromagnetics Research Symposium (PIERS) Proceedings, Xi'an, China, March 22-26, 2010.
[4] D. Sievenpiper, “Review of Theory, Fabrication, and Applications of High Impedance Ground Planes,” Metamaterials: Physics and Engineering Explorations, IEEE Press by J. Wiley & Sons, Hoboken, N.J., 2006.
[5] K. Golla, M S. Thesis, “Broadband Applications of High Impedance Ground Planes,” Storming Media, Washington, D.C., 2001.
[6] F. W. Grover, Inductance Calculations, D. Van Nostrand, New York, N.Y., 1946.

### BACKGROUND OF THE INVENTION

The work of Sievenpiper [1] and others [2] describe the use of electromagnetic bandgap (EBG) planar structures to produce planar surfaces which act as perfect magnetic conductors (PMC). A mushroom shaped planar structures has been used and typically is made from uniform unit cells arranged in a regular pattern to produce a high-impedance surface over a narrow band of frequencies. Elements radiating in the narrow band covered by this unit cell of uniform dimension, and which are located near these EBG structures, show a significantly improved far-field performance when compared to these elements placed near a perfect electric conductor (PEC) surface. This approach allows improvements in the performance of low-profile antenna structures.

Several groups have reported methods whereby the bandwidth of high-impedance surfaces can be increased [3-5]. These have included varying the dielectric constant of a substrate behind the antenna and also varying the density or thickness of the substrate across the dimensions of the antenna.

There remains a need for a high-impedance surface design with capability to perform over a wide bandwidth.

The present invention presents an improved method for implementing a wideband antenna by using an EBG structure where the cell geometry gradually changes with position. An example of this variation includes changes in geometry dimensions of the mushroom structure that increase with increasing radius. Other shapes and geometries are possible, such as linear and rectangular shapes.

Bandwidths of over a decade in high-impedance and far-field performance have been achieved for a low-profile antenna when a wideband antenna such as a planar spiral antenna or a log-periodic array is employed with the present design of an EBG metamaterial substrate.

For a better understanding of the invention, its operating advantages and the specific objects attained by its uses, reference should be made to the accompanying drawings and descriptive matter in which there are illustrated preferred embodiments of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiments in addition to the scope of the invention illustrated by the accompanying drawings.

### BRIEF DESCRIPTION OF THE DRAWINGS

The foregoing and other objects, features and advantages of the invention will become more fully understood from the following description of the preferred embodiments of the invention as illustrated in the accompanying drawings in which like reference characters refer to the same parts throughout different views. The drawings are not necessarily to scale, emphasis instead being placed upon illustrating the principles of the invention.

FIG. 1 is the detailed geometry and circuit model of a mushroom shaped electromagnetic bandgap structure.

FIG. 2(a) is a sketch of a typical array configuration of electromagnetic bandgap structures of uniform size.

FIG. 2(b) is a sketch of a typical spiral radiating antenna that exhibits broadband characteristics in free space.

FIG. 3(a) is a sketch of an array configuration of electromagnetic bandgap structures having dimensions that increase with radius.

FIG. 3(b) is a sketch of typical spiral radiating antenna that exhibits broadband characteristics in free space.

FIG. 4 is a plot showing the return loss (S-parameter 511 in dB) as a function of frequency and depicts an improved impedance bandwidth for the wideband EBG structure.

FIG. 5 shows a typical spiral antenna with the active radiating region shown.

FIG. 6 shows a wideband EBG reference structure where the dimensions of the EBG cells vary with radius so that at each resonant region radius the EBG cells provide a high impedance surface to the resonant frequency.

FIG. 7 shows a 3 by 3 array of the uniform geometry mushroom shaped EBG structure.

FIG. 8 shows a unit cell of the mushroom shaped EBG structure.

FIG. 9 is a plot of the phase of the S11 parameter versus frequency for several incident angles of the transverse magnetic (TM) wave.

FIG. 10 shows the EBG structure from a side view and end view along with a depiction of how the antenna interacts with the high impedance surface.

### DETAILED DESCRIPTION OF THE INVENTION

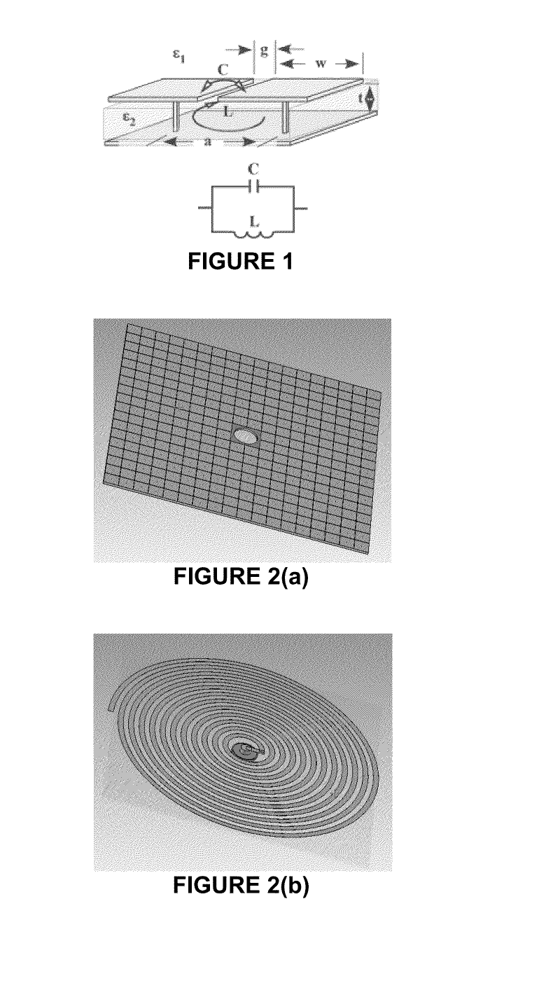

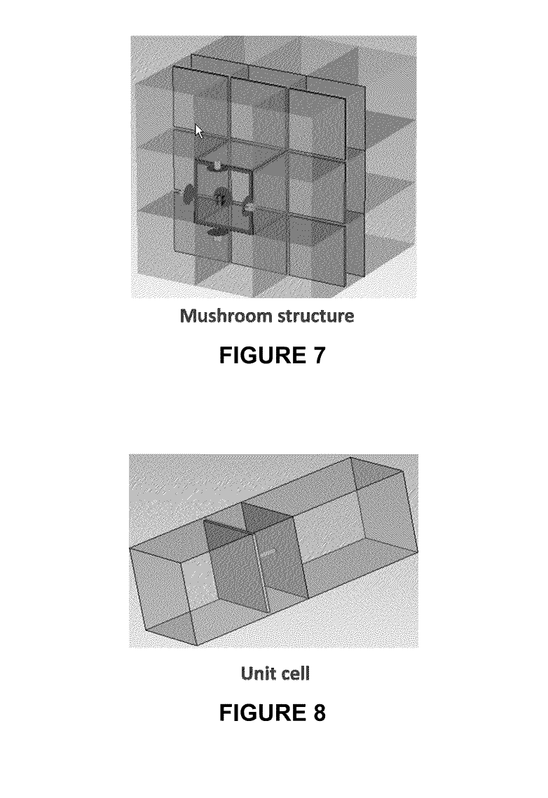

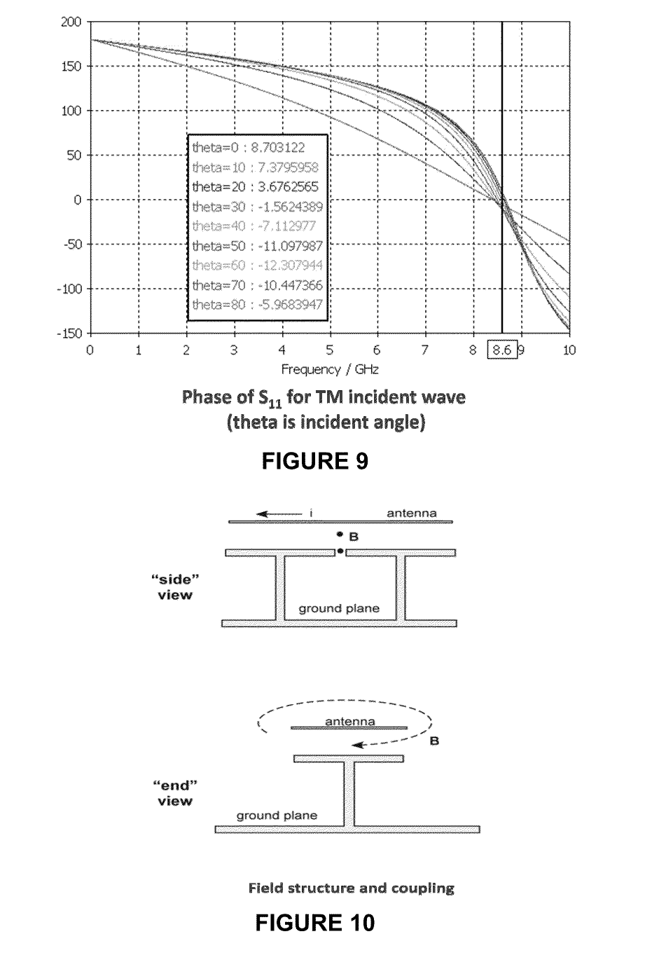

The mushroom planar structures such as shown in FIG. 1, FIG. 7 and FIG. 8 are typically made from uniform unit cells arranged in a regular pattern to produce a high-impedance surface over a narrow band of frequencies. A 3 by 3 arrangement of uniform unit cells is shown in FIG. 7. FIG. 2(a) shows a larger array of uniform unit cells. Elements radiating in the narrow band covered by this unit cell of uniform dimension, and which are located near these EBG structures, show a significantly improved far-field performance when compared to these elements placed near a perfect electric conductor (PEC) surface. This approach allows improvements in the performance of low-profile antenna structures.

Several groups have reported methods whereby the bandwidth of high-impedance surfaces can be increased [3-5]. These have included varying the dielectric constant of a substrate behind the antenna and also varying the density or thickness of the substrate across the dimensions of the antenna.

The present invention presents an improved method for implementing a wideband antenna by using an EBG structure where the cell geometry gradually changes with position. An example of this variation is shown in FIG. 6 where the dimensions of the mushroom structure are shown to increase with increasing radius. Other shapes and geometries are possible, such as linear and rectangular shapes. The circular shape shown herein is just an example for illustration.

Bandwidths of over a decade in high-impedance and far-field performance have been achieved for a low-profile antenna when a wideband antenna such as a planar spiral antenna or a log-periodic array is employed with the present design of an EBG metamaterial substrate.

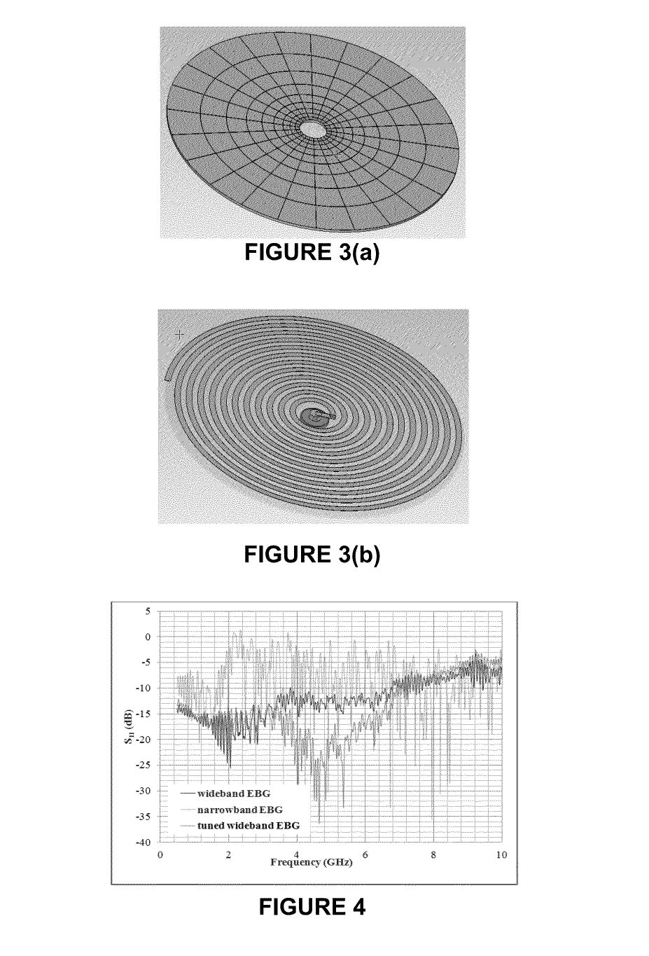

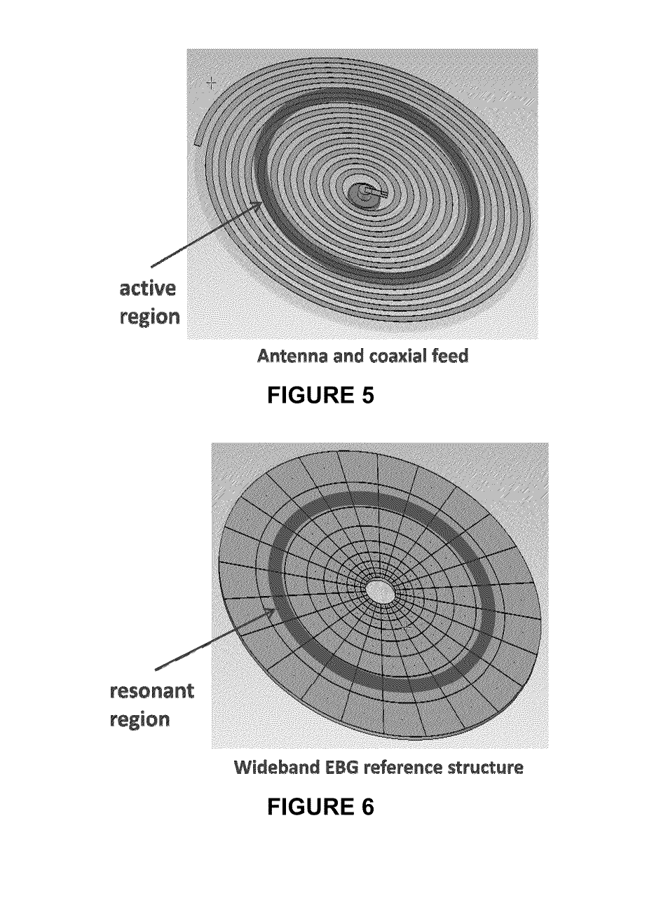

Planar spiral and log periodic array antennas, for a given frequency, radiate from localized regions. A spiral antenna is shown in FIG. 2(b), FIG. 3(b) and FIG. 5. Lower frequency radiation is enhanced in larger elements of the antenna or, in the case of a spiral antenna, from those elements with larger diameters. Similarly, higher frequency radiation is enhanced from smaller elements or, in spiral antennas, from those having smaller diameters. The central objective of the work herein is to describe the design of an EBG substrate where its geometry (and thus its resonant frequency) is linked to the geometry of the antenna. FIG. 5 and FIG. 6 illustrate the concept where the resonant region of the EBG structure forming the backplane for the antenna is matched to the active region of the antenna in FIG. 5.

For circular spiral antennas, the active region is located at different radial positions for different excitation frequencies; for log periodic arrays, the active region is located at different positions along the linear axis of the array for different excitation frequencies. In order for the active region of the antenna to be aligned with the corresponding EBG region of the substrate, the EBG geometry and antenna geometry should vary so that those areas of enhanced radiation occur at frequencies where the corresponding EBG substrate offers a high-impedance surface. This principle of localized coincidence of the active region of the antenna and the EBG region of the substrate underlies the design process described below.

To achieve variation of the EBG region along a particular coordinate axis requires that “resonance” of the meta-material structure vary along that axis, through changes in geometry and/or material properties. Following earlier work, each of the adjacent mushroom cells is considered small compared to wavelength so that they can be modeled by an equivalent L and C. The lumped element values are calculated from the geometry of the meta-material structure as shown in the FIG. 1.

Since the resonant frequency associated with a mushroom cell is given by ωₒ=1/\sqrt{LC}, EBG regions of lower frequency require larger L and/or C; higher frequencies require smaller L and/or C. Increasing the permittivity, permeability, or surface area of a cell will decrease the frequency of the EBG region; conversely decreasing the permittivity, permeability, or surface area will increase the frequency of the EBG region. The following section describes the calculation L and C of the unit cell of the meta-material substrate.

The capacitance between mushroom caps is primarily due to fringing fields between the plate surfaces rather than between plate edges and can be modeled using the equation below [2].

$$C \approx \frac{w ( {ɛ}_{1} + {ɛ}_{2} )}{π} {cosh}^{- 1} ( \frac{a}{g} )$$

Taking w=6.88 mm, g=0.1 mm, a=6.78 mm, t=1 mm, ∈₁=∈₀, and ∈₂=13.4∈₀, the capacitance is 1.33 pF.

Using these dimensions to determine the inductance, notice the current path includes planar surfaces on the top and bottom and wire-like paths with the vias on the right and left. If the vias were replaced by planar surfaces, the inductance could be modeled as L=μ₀t, giving approximately 1.26 nH. This model underestimates the inductance since the vias were replaced by plates. If the plates were replaced by wires, formulas from Grover [6] can be used to give an inductance of 6.52 nH. The actual inductance will lie between these two values. Taking the average provides an approximate inductance of 3.89 nH. This results in a predicted resonant frequency of approximately 2.2 GHz.

Inductance values from CST Microwave Studio, a finite element simulation tool, give an inductance of 3.06 nF, a value which continues to increase as frequency increases due to increasing current crowding on the top and bottom plates. Keeping in mind these are approximations, one should expect a resonant frequency in the vicinity of 2 GHz.

The reflection loss into two identical Archimedean spiral antennas will be compared. The first antenna will be placed above EBG structure with identical mushroom structures—geometry and materials described in the previous section. This uniform EBG array structure, shown in FIG. 2, will serve as a high-impedance surface over a narrow band of frequencies.

The second antenna will be placed above EBG structure where the cell geometry changes radially as shown in FIG. 3, where the mushroom plate area increases with radius, resulting in a resonant frequency that grows lower with increasing radius. This EBG structure serves as a high-impedance surface over a wider band of frequencies when compared to that in FIG. 2. The inner radius for the radial structure in FIG. 3 is 6 mm and the outer 60 mm. This results in a geometry comparable to that of the narrowband EBG at a radius of approximately 25 mm, with EBG structures at smaller radii offering high-z at higher frequencies and those at larger radii offering high-z at lower frequencies.

FIG. 4 shows a comparison of the return loss in decibels for the cases of the narrowband EBG, the present wideband EBG as well as the wideband EBG impedance as tuned using a simple discrete capacitive tuning correction, where the increased bandwidth offered by the EBG wideband substrate is evident.

The CST simulation of return loss of the spiral antenna over a narrowband EBG surface appears to show an octave bandwidth as evidenced by the −10 dB or smaller S11. The surface narrowband EBG response limits the wideband performance of the spiral antenna. On the other hand, similar simulation for the wideband structure shows a decade of bandwidth. Moreover, the return loss is −15 dB for nearly two octaves for the spiral antenna.

The example simulated in this paper matched the EBG resonance region to the active region of the spiral antenna at 2 GHZ. According to the foregoing discussion and equations, the EBG structure can be designed so that the position of the EBG resonance region matches the active region of the spiral antenna regardless of geometry, including circular, rectangular and linear antenna geometries.

For a better understanding of the invention, its operating advantages and the specific objects attained by its uses, reference should be made to the accompanying drawings and descriptive matter in which there are illustrated preferred embodiments of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiments in addition to the scope of the invention illustrated by the accompanying drawings.

It should be evident that the specific size and shape of each element can be modified to achieve the intent of this device.

While this version of the invention has been illustrated and described in detail in the drawings and foregoing description, the same is to be considered as illustrative and not restrictive in character, it being understood that only the preferred embodiments have been shown and described and that all changes and modifications that come within the spirit of the version of the invention are desired to be protected.

For instance, alternate versions of embodiments of the antenna can be provided with various dimensions and cell geometries. With respect to the above description then, it is to be realized that the optimum dimensional relationships for the parts of the invention, to include variations in sizes, lengths, diameters, materials, shape, form, function and manner of operation, assembly and use, are deemed readily apparent and obvious to one skilled in the art, and all equivalent relationships to those illustrated in the drawings and described in the specification are intended to be encompassed by the present invention.

Although this invention has been described in its preferred form with a certain degree of particularity, it is understood that the present disclosure of the preferred form has been made only by way of example and numerous changes in the details of construction and combination and arrangement of parts may be resorted to without departing from the spirit and scope of the invention.

What is claimed as the invention is:

1. An electromagnetic backplane for a radiating antenna element comprising:
electromagnetic bandgap structures having lateral and radial dimensions,
where the lateral and radial dimensions of the electromagnetic bandgap structures increase in size with increasing radius from the center of the radiating antenna element.

2. The electromagnetic backplane for a radiating antenna element of claim 1, where the shape of the electromagnetic backplane structures is rectangular.

3. The electromagnetic backplane for a radiating antenna element of claim 1, where the shape of the electromagnetic backplane structures is circular.

4. The electromagnetic backplane for a radiating antenna element of claim 1, where the shape of the electromagnetic backplane structures is elliptical.

5. A broadband antenna comprising:
a radiating antenna element, where the radiating antenna element has a resonance dimension that varies with frequency;
an electromagnetic bandgap structures having lateral and radial dimensions,
where the lateral and radial dimensions of the electromagnetic bandgap structures increase in size with increasing radius from the center of the radiating antenna element, and
where the lateral and radial dimensions of the electromagnetic bandgap structures are selected so that they are resonant at the same frequency as the antenna resonance dimension at a given radius.
